(19) United States
(12) Patent Application Publication
(10) Pub. No.: US 2026/0347029 A1
(43) Pub. Date: Nov. 5, 2026

(54) WINDING ASSEMBLY WITH VARIABLE RATIO

(71) Applicant: LOADHOG LIMITED, Sheffield, South Yorkshire (GB)

(72) Inventor: Allan MCCABE, Sheffield, South Yorkshire (GB)

(21) Appl. No.: 19/108,013

(22) PCT Filed: Sep. 1, 2023
(86) PCT No.: PCT/IB2023/058663

§ 371 Date: Feb. 28, 2025

(30) Foreign Application Priority Data
Sep. 1, 2022 (GB) 2212719.5

(51) Int. Cl. B65B 13/22; B65B 7/28; B65D 71/00

(52) U.S. Cl. CPC B65B 13/22; B65B 7/28; B65D 71/00

(57) ABSTRACT

There is provided a winding assembly (16), and a pallet lid (1) comprising the winding assembly (16). The winding assembly (16) comprises a rotatable tensioner (37) configured to receive a tensioning line (10) therethrough. The winding assembly (16) further comprises a manual control device (19) to rotate the tensioner (37) from a home position of the tensioner (37 ) to a tensioning position of the tensioner (37). The winding assembly (16) provides a variable ratio between movement of the manual control device (19) and a tensioning displacement of the tensioning line (10) as the tensioning line (10) is wrapped around the tensioner (37) by rotation of the tensioner (37) towards the tensioning position.

### FIELD OF THE INVENTION

Embodiments of the present invention relate to a winding assembly with a variable ratio. In particular, the winding assembly is a pallet lid winding assembly.

### BACKGROUND TO THE INVENTION

It is known to load goods on pallets. Lids can be mounted on the loads. Such lids are provided with straps to tighten the lid against the load when the ends of the straps as secured to the pallet. The lids include tightening mechanisms, operated by levers, to tighten the strap, thereby pulling the lid against the load. The lever may be turned many times to ratchet the straps tight.

### BRIEF DESCRIPTION OF VARIOUS EMBODIMENTS OF THE INVENTION

According to an aspect of the invention there is provided a winding assembly comprising:
a rotatable tensioner configured to receive a tensioning line (e.g., strap, wire or the like) therethrough; and
a manual control device to rotate the tensioner from a home position of the tensioner to a tensioning position of the tensioner,
wherein the winding assembly provides a variable ratio between movement of the manual control device and a tensioning displacement of the tensioning line as the tensioning line is wrapped around the tensioner by rotation of the tensioner towards the tensioning position.

The effect is enabling greater control over the force required from the user to wind the tensioner to the tensioning position. This is because the variable ratio defines a variable mechanical advantage throughout a stroke of the manual control device.

The variable ratio may reduce the tensioning displacement of the tensioning line as the manual control device moves towards an end of a stroke of the manual control device.

An advantage is that the manual control device is easy to move because the variable ratio compensates for the increasing reaction force from the tensioning line as an angle of the tensioner approaches the tensioning position.

The tensioner may provide the variable ratio.

The tensioner may have an axis of rotation. The tensioner may comprise a winding surface arranged around the axis of rotation of the tensioner. The winding surface may be a curved surface. The tensioner may have a cylindrical shape or a prismatic shape, defining the winding surface. The tensioner may be in the form of a spindle.

The tensioner may have a variable radius around the axis of rotation, to provide the variable ratio. The winding surface may define the variable radius. The winding surface may be spiral shaped.

An advantage is that the variable ratio is achieved with a single/existing part, by adapting its geometry.

The tensioner may be rotatable towards the tensioning position in a decreasing-radius direction of rotation. The decreasing-radius direction of rotation may be defined by the variable radius of the winding surface.

The variable radius of the tensioner may have a variable rate of change around the axis of rotation. For example, the spiral shape may be a logarithmic spiral.

An advantage is that the force required from the user to wind the tensioner to the tensioning position remains approximately constant over the whole stroke of the manual control device.

The tensioner may comprise a slot through which the tensioning line can extend. The tensioning line may comprise a strap which can extend through the slot. The slot may have a first aperture and a second aperture. The first aperture and second aperture may be apertures in the winding surface. The slot may extend through the axis of rotation. The tensioner may be in the form of a slotted spindle.

Rotation of the tensioner rotates the slot, to wind the tensioning line around the tensioner. The tensioning line may be wound around the winding surface of the tensioner.

An angular distance from the home position of the tensioner to the tensioning position of the tensioner may be greater than 180 degrees or at least 235 degrees or at least approximately 270 degrees.

The tensioner may provide the variable ratio by having a first radius proximal to the first aperture which is greater than a second radius proximal to the second aperture, the second aperture being opposite the first aperture. The tensioner may be rotatable towards the tensioning position in a direction for wrapping the tensioning line around the tensioner at a decreasing winding radius from the first radius to or through the second radius.

The tensioner may be rotatable towards the tensioning position in a direction for wrapping the tensioning line around the tensioner, at a decreasing winding radius from the first radius, through the second radius, to a third radius less than the second radius. The value of the winding radius may be the third radius when the tensioner is at the tensioning position.

The third radius may be angularly separated from the first radius by more than 180 degrees or by at least 235 degrees or by at least approximately 270 degrees.

The variable radius of the tensioner may decrease continuously from the first radius to the second radius. The variable radius of the tensioner may decrease continuously from the second radius to the third radius.

The first radius may be a maximum radius of the winding surface. The first radius may be at a first edge of the first aperture. The second radius, less than the first radius, may be at an edge of the second aperture. A minimum radius of the winding surface may be at a second edge of the first aperture. The third radius may be between the second radius and the minimum radius.

The manual control device may have a stroke length associated therewith, wherein actuation of the manual control device by a single stroke length in a first, tensioning direction rotates the tensioner from the home position of the tensioner to the tensioning position of the tensioner.

An advantage is intuitive operation because only a single stroke of the manual control device is required to reach the target tension, rather than a ratcheting motion. The variable ratio solves a problem involved with single stroke operation, the problem being that the force required for a single stroke is greater compared to the situation in which the tensioning can occur over multiple strokes (e.g., via ratcheting). The variable ratio is useful for ensuring that the required user force does not increase significantly towards the end of the stroke, when tension is highest.

When the tensioning position is reached, a retainer may be engaged to prevent movement of the manual control device and/or the tensioner in an opposite direction. The retainer may be engaged in dependence on the manual control device reaching a full stroke position corresponding to the tensioning position of the tensioner. The engagement may be automatic. The retainer may prevent the manual control device from returning from the full stroke position to a rest position corresponding to the home position of the tensioner.

An advantage of the retainer is that operation of the winding assembly is more intuitive. This is because engagement of the retainer provides clear feedback that the tensioning line has been tensioned to the predetermined target tension that the manufacturer has determined to be an appropriate amount of tension. The manual control device may be in the form of a lever. The lever may comprise a fulcrum body and an elongate handle extending from the fulcrum body.

The winding assembly may comprise a drive linkage coupling actuation of the manual control device to motion of the tensioner.

The winding assembly may comprise a return spring. The return spring may be in a tensioner load path between the manual control device and the tensioner. The return spring may apply a bias force to bias the tensioner from the tensioning position of the tensioner towards the home position of the tensioner. However, the engagement of the retainer as described above may keep the tensioner in its tensioning position. The bias force of the return spring may also reach the manual control device via the drive linkage. Therefore, the return spring may simultaneously bias the tensioner towards the home position and bias the manual control device towards a rest position of the manual control device.

An advantage of the return spring is intuitive operation, because if the user does not move the manual control device enough to reach the correct tension, the retainer will not engage. If the user releases the manual control device without the retainer being engaged, the manual control device will return back to its rest position. The manual control device is therefore stable in two binary positions its rest position and its full stroke position at which the retainer is engaged.

The winding assembly may comprise a releaser. The releaser may provide an input in the form of a release button. The releaser may be push-to-release. The releaser may be exterior-facing and deflectable by a user's digit pushing the releaser, to deflect the retainer (e.g., spring-loaded catch) out of engagement with the manual control device.

The releaser may be an exterior part of the winding assembly. The releaser, and the elongate handle of the manual control device, may both be exterior (externally visible, exterior-facing) parts of the winding assembly.

An advantage of the exposed releaser is intuitiveness, because the user can immediately see what needs to be done to release the manual control device. This reduces the likelihood of misuse by users attempting to free the manual control device in a different way than intended.

The drive linkage of the winding assembly may comprise a driver actuatable by the manual control device, and the tensioner may comprise a drive input directly or indirectly coupled to the driver and actuated by the driver. The driver and/or the tensioner drive input may be a non-slip drive comprising a mesh drive or a cable actuator.

An advantage of the use of a non-slip drive linkage is more precise control of the tensioner, compared to ratchets or pulleys. This means that when the manual control device is actuated until the retainer is engaged, the total mechanical work done by the manual control device is consistent and predictable, resulting in a predictable amount of tension so that the tensioning line is neither too tight nor too loose. The user no longer has to judge the correct amount of tension.

The manual control device may be rotatable about a manual control device axis of rotation. The manual control device axis of rotation may be an upwards axis such as a vertical axis. Therefore, the manual control device may rotate laterally.

The tensioner may be rotatable about a tensioner axis of rotation different from the manual control device axis of rotation. The tensioner axis may be a lateral axis. The tensioner axis may be perpendicular to the manual control device axis. The drive linkage of the winding assembly may connect the manual control device axis of rotation to the tensioner axis of rotation.

An advantage of the direction change is that the winding assembly has a low vertical height, because the manual control device rotates laterally. Therefore, the winding assembly is suitable for use as a pallet lid winding assembly.

The winding assembly may comprise a drum axle configured to receive a drum from which the tensioning line can be unwound and to which the tensioning line can be wound. The drum axle may comprise an urger, such as a spiral spring, to bias a drum fitted to the drum axle in a winding direction. The urger may therefore bias the tensioning line in the winding direction. If the tensioning line is wound around the tensioner, this may have the effect of pulling the tensioner in a rotation direction towards the home position of the tensioner. The urger may or may not exert a strong enough pull to rotate the tensioner to the home position of the tensioner. Therefore, a return spring as described above may be provided to ensure a consistent return of the tensioner to its home position.

According to a further aspect of the invention there is provided a pallet lid comprising the winding assembly as described in any of the preceding statements.

### BRIEF DESCRIPTION OF THE DRAWINGS

For a better understanding of various examples of embodiments of the present invention reference will now be made by way of example only to the accompanying drawings in which:

FIG. 1 is a perspective view of a lid in use on a load;

FIG. 2 is a perspective view of a winding assembly for use in the lid shown in FIG. 1, before a strap is tensioned;

FIG. 3 is a perspective view of a winding assembly before tensioning a strap;

FIG. 4 is a perspective view of the winding assembly of FIG. 3 after tensioning the strap;

FIG. 5 is a side cross-section view of a tensioner; and

FIGS. 6A-6D are side cross-section views of the tensioner rotated to different angles.

### DETAILED DESCRIPTION OF VARIOUS EMBODIMENTS OF THE INVENTION

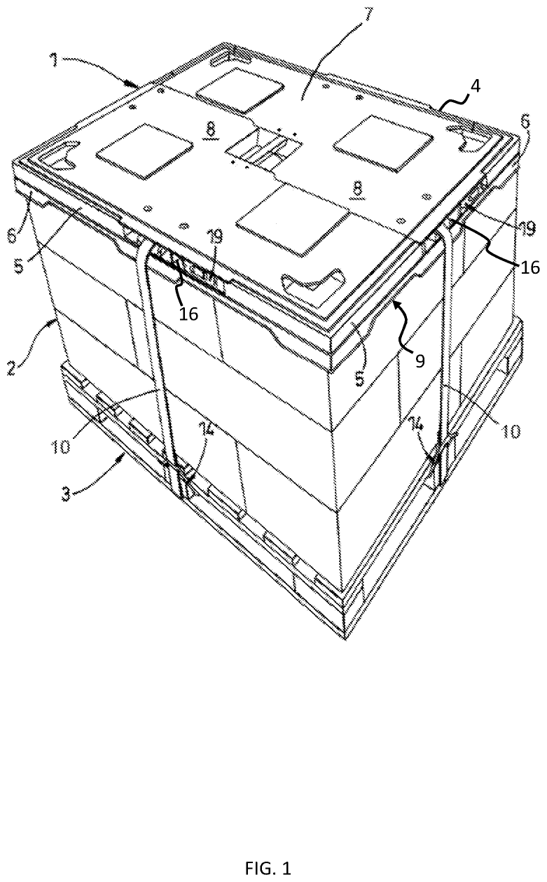

FIG. 1 shows a lid 1 for securing a load 2 on a pallet 3. The lid 1 comprises a body 4 with upstanding sides 5 and depending skirt 6 for capping the top sides of the load 2 (and also enabling a plurality of the lids 1 to be nested with each other or with pallets).

The body 4 comprises an upper portion 7 shown formed by a plurality of plastics mouldings 8, but which could be formed as a single moulding. The body 4 further includes a lower portion 9 formed by a main plastics moulding.

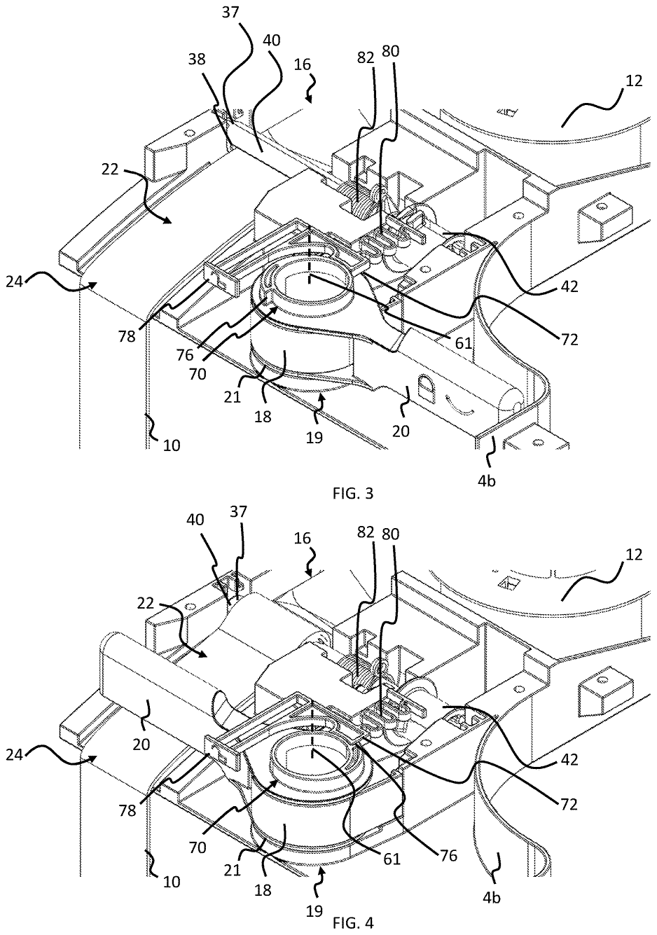

The lid 1 includes four tensioning lines in the form of straps 10. Each tensioning line 10 is movable between a retracted condition within the upper portion 7, and an extended condition in which the tensioning line 10 extends from the upper portion 7. Each tensioning line 10 is provided at a respective side of the lid 1. Each tensioning line 10 has a distal end to which an anchor 14 is attached. An anchor 14 can comprise a hook, loop or any other suitable attacher. In the extended condition of the tensioning lines 10, the anchors 14 can be secured to the pallet 3. As shown in FIGS. 3-4, each tensioning line 10 also has a proximal end attached to a drum 12.

When the anchors 14 are secured to the pallet 3, as shown in FIG. 1, the tensioning lines 10 can then be tensioned by the use of respective winding assemblies 16 operable on each tensioning line 10. Each winding assembly 16 is provided within the body 4.

Only two of the tensioning lines 10 are visible in FIG. 1, extending from two of the sides of the body 4. The skilled person will realise that the other two tensioning lines 10 extend from the other two sides. Each tensioning line 10 may have its own winding assembly 16.

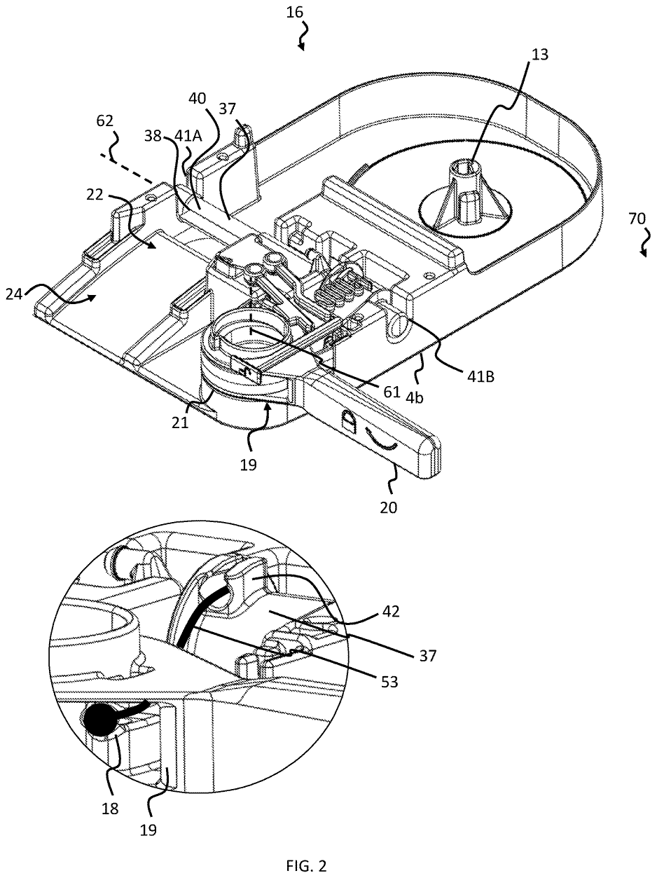

FIGS. 2-4 illustrate example winding assemblies 16. The winding assembly 16 may comprise a plastic moulding securable to a winding assembly aperture in an upstanding side 5 of the body 4 of the lid 1, for example. Alternatively, the winding assembly 16 may be integrally moulded with the body 4 of the lid 1.

The winding assembly 16 comprises a drum axle 13 configured to receive the drum 12 from which the tensioning line 10 can be unwound when in use, and to which the tensioning line 10 can be re-wound when not in use.

The drum axle 13 may comprise an urger (hidden from view), such as a spring connected at one end to the drum axle 13 and at the other end to the drum 12. The urger rotatably biases the drum 12 in a winding direction to wind the tensioning line 10 on the drum 12, to move the tensioning line 10 to its retracted condition. For example, the urger may comprise a spiral spring.

The tensioning line 10 extends away from the drum 12 along a tensioning line channel 22 and through a tensioning line opening 24 in the lateral exterior of the winding assembly 16. The tensioning line channel 22 interconnects a drum cavity/the drum 12 with the tensioning line opening 24. The anchor 14 of the tensioning line 10 may be oversized relative to the tensioning line opening 24 so that the distal end of the tensioning line 10 can be easily retrieved and is not ‘swallowed’ by the winding assembly 16.

Each winding assembly 16 comprises a tensioner 37 in the form of a slotted spindle 40. The tensioner 37 is actuated to pull the tensioning line 10 once the anchor 14 of the tensioning line 10 has been secured to the pallet 3.

The tensioner 37 is rotatably mounted in the winding assembly 16. The tensioner 37 spans across the tensioning line channel 22 and engages with the tensioning line 10. The illustrated tensioner 37 is rotatable about a lateral, tensioner axis of rotation 62 perpendicular to the vertical axis of rotation of the drum 12. This ensures that the winding assembly 16 is low-height.

The tensioner 37 is rotatable by operation of a drive linkage actuated by a manual control device in the form of a lever 19. The illustrated lever 19 comprises a fulcrum body 21 and an elongate handle 20 extending from the fulcrum body 21, which a user can turn.

The lever 19 is operated by being pivotally moved about a lever axis of rotation 61 from a rest position (FIG. 3) to the end of its stroke length (FIG. 4). The lever axis of rotation 61 may be an upwards axis such as a vertical axis. Therefore, the lever 19 may move laterally. This ensures that the winding assembly 16 is low-height.

The illustrated tensioner 37 is in the form of a slotted spindle 40 because the tensioner 37 is rotatable and comprises a slot 38 through which the tensioning line 10 passes. The tensioner 37 is rotatably held in the winding assembly 16 by shaft supports 41A, 41B. By rotating the tensioner 37 after the tensioning line 10 has been anchored to the pallet 3, the tensioning line 10 is wound around the tensioner 37 which pulls the tensioning line 10 to tension the tensioning line 10.

The movement of the lever 19 from the rest position of the lever 19 to the end of the stroke length of the lever 19 rotates the tensioner 37 from a home position of the tensioner 37 to a tensioning position of the tensioner 37. This wraps the tensioning line 10 around the tensioner 37 to tension the anchored tensioning line 10. Only one stroke of the lever 19 is necessary.

When the tensioner 37 is at the home position, its slot 38 may be aligned with the direction in which the tensioning line 10 can be wound and unwound, to not resist pulling of the tensioning line 10 therethrough. The slot 38 may be parallel to the tensioning line channel 22. The slot 38 may face the tensioning line opening 24.

When the tensioner 37 is at the tensioning position, as shown in FIG. 4, the tensioning line 10 is sufficiently wound around the tensioner 37 to tension the tensioning line 10 and frictionally react against further unwinding of the tensioning line 10.

The angular distance from the home position of the tensioner 37 to the tensioning position of the tensioner 37 may be a reflex angle. The lever 19 may have a stroke length of approximately 180 degrees (or a different, obtuse angle). Only one stroke of the lever 19 (e.g., 180 degrees) is necessary to rotate the tensioner 37 by the reflex angle (e.g., 300 degrees).

As shown in the detail view of FIG. 2, a drive linkage is provided in the form of a cable actuator 53 connected at one end to a first seat 18 mounted to the lever 19, and connected at its opposite end to a second seat 42 mounted to the tensioner 37. It would be appreciated that a different form of drive linkage could be provided, in other examples.

Referring to FIGS. 3-4, the winding assembly 16 is provided with a retainer 70. The retainer 70 is configured to engage following actuation of the lever 19 in a first, tensioning direction (from the rest position of the lever 19 to the end of the stroke length of the lever 19), to prevent movement of the elongate handle 20 of the lever 19 in a second, opposite direction despite the bias force from the urger of the drum axle 13 biasing the lever 19 back towards its rest position.

FIG. 3 shows the lever 19 at its rest position wherein the tensioner 37 is at its home position. FIG. 4 shows the lever 19 at its full stroke position wherein the tensioner 37 is at its tensioning position. In FIG. 4, the retainer 70 is engaged. The retainer 70 comprises a single-drop spiral cam 76 comprised in the fulcrum body 21 of the lever 19, and a spring-loaded catch 72 configured to engage with the spiral cam 76. The axis of the spiral cam 76 may be coaxial with the lever axis of rotation 61. The illustrated spiral cam 76 is above the drive linkage, but could alternatively be below the drive linkage.

As the lever 19 is rotated to the full stroke position shown in FIG. 4, the rotating spiral cam 76 deflects the catch 72, acting against the spring 80 of the catch 72. In FIG. 4, the catch 72 has fallen into the drop of the spiral cam 76. Therefore, when the user releases the handle 20, the lever 19 remains stationary because the spiral cam 76 is unable to back-rotate due to the engagement between the catch 72 and the drop of the spiral cam 76.

The catch 72 operates in the manner of a one-way gate that the spiral cam 76 can enter but cannot leave without first undoing the catch 72. The catch 72 is implemented as a spring-loaded catch 72.

As shown in FIGS. 3-4, the elongate handle 20 and the tensioning line opening 24 are exterior parts of the winding assembly 16. They are at an upstanding side 5 of the lid 1 of FIG. 1. Therefore, a user can grab the elongate handle 20, turn the lever 19 and feel the elongate handle 20 being engaged by the retainer 70. The engagement of the retainer 70 provides clear haptic feedback that the tensioning line 10 is now sufficiently tensioned.

To release the elongate handle 20 from the retainer 70, the user pushes a releaser in the form of a release button 78 with their finger, to separate the catch 72 from the drop of the spiral cam 76. The release button 78 is sized to receive a user's fingertip.

This disengagement of the retainer 70 by the release button 78 is sufficient to allow the urger of the drum axle 13 to pull the line 10 hard enough to rotate the tensioner 37 back to its home position, the back-rotation of the tensioner 37 causing rotation of the lever 19 back to its rest position. The tensioning line 10 is now slack which allows the user to separate the anchor 14 from the pallet 3 and retract the tensioning line 10.

The release button 78, the catch 72, and optionally the spring 80, may be an integral part such as an integrally-moulded part. This obviates the need for a mechanism connecting the release button 78 to the catch 72, or multiple parts during manufacture.

For intuitive use, the release button 78 is an exterior part of the winding assembly. The release button 78 is adjacent the lever 19. The release button 78 is exposed at the upstanding side 5 of the lid 1 of FIG. 1. The spring 80 may be internal and anchored against a part of the lid 1 of FIG. 1.

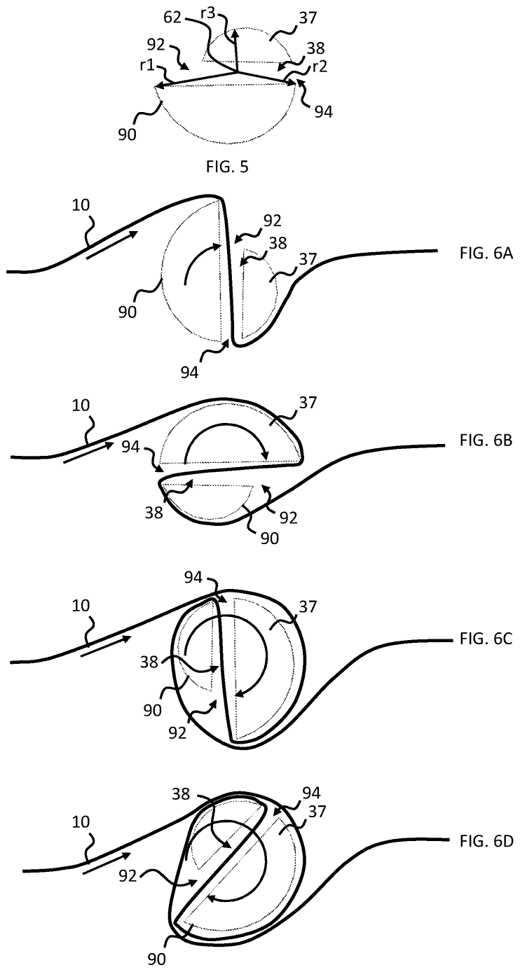

It would be appreciated that a different type of retainer and/or releaser could be implemented than that shown, such as a manually operated latch arrangement. FIG. 5 shows a cross-section through a cylindrical section of the tensioner 37 comprising the slot 38. The slot 38 has a first aperture 92 and a second aperture 94, which are apertures in a winding surface 90 of the tensioner 37 around which the strap 10 can be wound.

The strap 10 extends through the apertures 92, 94 and slot 38, as shown in FIGS. 6A-6D. As the tensioner 37 is rotated, the strap 10 is wound around the winding surface 90 and starts to roll up, in the manner shown in FIGS. 6A-6D. The winding surface 90 of the tensioner 37 has a spiral shape, in this case a logarithmic spiral shape, to modify the ratio between movement of the lever 19 and tensioning displacement of the strap 10 as the strap 10 is wrapped around the tensioner 37 by rotation of the tensioner towards the tensioning position.

The term ‘spiral’ would be understood to cover continuously curved spirals without vertices, spirals formed from segments connected by vertices, or a combination thereof. The Figures show a continuously curved spiral.

The winding surface 90 defines a winding radius. The winding radius is defined as follows: if a straight radial line is drawn from the axis of rotation 62 to the location in which the strap 10 makes winding contact with the tensioner 37, the winding radius is defined as the radius of the winding surface 90 along that straight radial line. This ignores a rolling-up effect of the strap 10. A circular winding surface 90 would have a constant winding radius.

As a result of the spirally decreasing radius of the winding surface 90, the tensioning displacement of the strap 10 decreases for each equal incremental movement of the lever 19 from the rest position towards the full stroke position, and for each corresponding equal incremental rotation of the tensioner 37 from its home position to its tensioning position. This minimizes or prevents any increase in user force required towards the end of travel of the lever 19, as the tension in the wire 10 reaches a maximum.

As shown in FIG. 5, the radius of the spiral winding surface 90 from the axis 62 decreases from a first maximum radius r1, through a smaller second radius r2, and to or through an even smaller third radius r3.

As annotated in FIG. 5, the first radius r1 is from the tensioner axis of rotation 62 to a first edge of the first aperture 92. The winding radius is equal to the first radius r1 as rotation of the tensioner 37 from the home position is initiated. As shown in FIG. 6A, the first edge of the first aperture 92 pulls the strap 10 as the tensioner 37 is rotated by its first 90 degrees from FIG. 5 to FIG. 6A.

As the tensioner 37 is then rotated from 90 degrees to 180 degrees as shown in FIG. 6B, the strap 10 wraps around the winding surface 90 which has a continuously decreasing radius from the first radius r1 towards the second radius r2. This 90 degree rotation from FIGS. 6A-6B is therefore easier than the previous 90 degree rotation from FIGS. 5-6A.

As the tensioner 37 is then rotated from 180 degrees to 270 degrees as shown in FIG. 6C, the strap 10 wraps around the second aperture 94 and starts to wrap around itself. As the strap 10 wraps around the second aperture 94, the winding radius becomes equal to the second radius r2 which is the radius at an edge of the second aperture 94, and less than the first radius r1. This 90 degree rotation from FIGS. 6B-6C is therefore easier than the previous 90 degree rotation from FIGS. 6A-6B.

As the tensioner is then rotated from 270 degrees to its final tensioning position (e.g., approx. 300 degrees) as shown in FIG. 6D, the strap 10 continues to wrap around itself. At the tensioning position, the winding radius is equal to the third radius r3 which is significantly less than the first radius r1. This final rotation is therefore easier than the previous rotation of FIG. 6C.

The third radius r3 may be equal to or almost equal to the minimum radius of the winding surface 90. In the illustrated example, the minimum radius of the winding surface 90 is at the second edge of the first aperture 92, adjacently opposing the first edge of the same first aperture 92.

If the rate of change of the radius is variable to define a logarithmic spiral or equivalent growth spiral, then this reduces the rate of change of the otherwise-exponential increase in user force required towards the full stroke position of the lever 19. In other examples, other types of growth spiral may be used such as a hyperbolic spiral or an archimedian spiral. During testing, some logarithmic spiral samples were found to enable a more constant force than other types of growth spiral.

Although embodiments of the present invention have been described in the preceding paragraphs with reference to various examples, it should be appreciated that modifications to the examples given can be made without departing from the scope of the invention as claimed. For example, a different part of the winding assembly may provide the variable ratio than the tensioner. Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A winding assembly comprising:
a rotatable tensioner configured to receive a tensioning line therethrough; and
a manual control device to rotate the tensioner from a home position of the tensioner to a tensioning position of the tensioner,
wherein the winding assembly provides a variable ratio between movement of the manual control device and a tensioning displacement of the tensioning line as the tensioning line is wrapped around the tensioner by rotation of the tensioner towards the tensioning position.

2. The winding assembly of claim 1, wherein the variable ratio reduces the tensioning displacement of the tensioning line as the manual control device moves towards an end of a stroke of the manual control device.

3. (canceled)

4. The winding assembly of claim 13, wherein the tensioner has an axis of rotation, and wherein the tensioner has a variable radius around the axis of rotation, to provide the variable ratio.

5. The winding assembly of claim 4, wherein the tensioner comprises a winding surface arranged around the axis of rotation of the tensioner, and wherein the winding surface defines the variable radius.

6. The winding assembly of claim 5, wherein the tensioner is rotatable towards the tensioning position in a decreasing-radius direction of rotation, and wherein the decreasing-radius direction of rotation is defined by the variable radius of the winding surface.

7. The winding assembly of claim 4, wherein the variable radius of the tensioner has a variable rate of change around the axis of rotation.

8. The winding assembly of claim 1, wherein an angular distance from the home position of the tensioner to the tensioning position of the tensioner is greater than 180 degrees or at least 235 degrees.

9. The winding assembly of claim 1, wherein the tensioner comprises a slot through which the tensioning line can extend, and wherein the slot has a first aperture and a second aperture.

10. The winding assembly of claim 9, wherein rotation of the tensioner rotates the slot, to wind the tensioning line around the tensioner.

11. The winding assembly of claim wherein the tensioner provides the variable ratio by having a first radius proximal to the first aperture which is greater than a second radius proximal to the second aperture, the second aperture being opposite the first aperture.

12. The winding assembly of claim 11, wherein the variable radius of the tensioner decreases continuously from the first radius to the second radius.

13. The winding assembly of claim 11, wherein the tensioner is rotatable towards the tensioning position in a direction for wrapping the tensioning line around the tensioner at a decreasing winding radius from the first radius to or through the second radius.

14. The winding assembly of claim 13, wherein the decreasing winding radius is from the first radius, through the second radius, to a third radius less than the second radius, and wherein a value of the winding radius is the third radius when the tensioner is at the tensioning position.

15. The winding assembly of claim 14, wherein the variable radius of the tensioner decreases continuously from the second radius to the third radius.

16. The winding assembly of claim 14, wherein the first radius is a maximum radius of the winding surface, wherein the first radius is at a first edge of the first aperture, wherein the second radius, less than the first radius, is at an edge of the second aperture, wherein a minimum radius of the winding surface is at a second edge of the first aperture, and wherein the third radius is between the second radius and the minimum radius.

17. The winding assembly of claim 1, wherein the manual control device has a stroke length associated therewith, wherein actuation of the manual control device by a single stroke length in a first, tensioning direction rotates the tensioner from the home position of the tensioner to the tensioning position of the tensioner.

18. The winding assembly of claim 1, wherein when the tensioning position is reached, a retainer is engaged to prevent movement of the manual control device and/or the tensioner in an opposite direction.

19. (canceled)

20. (canceled)

21. (canceled)

22. (canceled)

23. The winding assembly of claim 1, comprising a drum axle configured to receive a drum from which the tensioning line can be unwound and to which the tensioning line can be wound.

24. (canceled)

25. A pallet lid comprising the winding assembly as claimed in claim 1.

26. The winding assembly of claim 1, wherein the tensioner comprises a slot through which the tensioning line can extend, and wherein the slot has a first aperture and a second aperture, the second aperture being opposite the first aperture, wherein the tensioner has an axis of rotation, wherein the tensioner has a variable radius around the axis of rotation, wherein the tensioner comprises a winding surface arranged around the axis of rotation of the tensioner, and wherein the winding surface defines the variable radius, wherein rotation of the tensioner is configured to rotate the slot, to wind the tensioning line around the tensioner, wherein the manual control device has a stroke length associated therewith, wherein actuation of the manual control device by a single stroke length in a first, tensioning direction is configured to rotate the tensioner from the home position of the tensioner to the tensioning position of the tensioner, wherein the variable ratio reduces the tensioning displacement of the tensioning line as the manual control device moves towards an end of a stroke of the manual control device, wherein the variable radius of the tensioner provides the variable ratio, wherein the tensioner is configured to be rotatable towards the tensioning position in a decreasing-radius direction of rotation, wherein the decreasing-radius direction of rotation is defined by the variable radius of the winding surface, wherein the tensioner provides the variable ratio by having a first radius proximal to the first aperture which is greater than a second radius proximal to the second aperture, wherein the tensioner is rotatable towards the tensioning position in a direction for wrapping the tensioning line around the tensioner at a decreasing winding radius from the first radius to or through the second radius, wherein the decreasing winding radius is from the first radius, through the second radius, to a third radius less than the second radius, and wherein a value of the winding radius is the third radius when the tensioner is at the tensioning position.
